(19) United States
(12) Patent Application Publication
(10) Pub. No.: US 2005/0149421 A1
(43) Pub. Date: Jul. 7, 2005

(54) Collateralized variable rate demand notes as a leverage supplement

(76) Inventors: Joanne Marlowe-Noren, Wadsworth, IL (US); Terry A. Temescu, Fort Lauderdale, FL (US)

Correspondence Address: Paul E. Schaafsma, Suite 221, 521 West Superior, Chicago, IL, 60610, US

(21) Appl. No.: 11/038,804

(22) Filed: Jan. 20, 2005

Related U.S. Application Data
(63) Continuation-in-part of application No. 10/400,211, filed on Mar. 27, 2003.

(51) Int. Cl. G06F 17/60

(52) U.S. Cl. 705/35

(57) ABSTRACT

A financial process and method of leveraging certain financing instruments is disclosed that includes a deployment of the CVRDN financial instrument specifically within the venture capital and investment banking market sector. A CVRDN Series is issued in such a way as to create leveraged returns. The CVRDN Series enables increased gains while simultaneously limiting leveraged risk/exposure. The proceeds from the CVRDNs are placed on deposit in a reserve account in such manner as to create the potential for a positive arbitrage of those funds that is sufficient to fully offset CVRDN interest payable while investment opportunities are being identified. The CVRDN Proceeds are deployed with a selection of credit underwriters that are willing to issue Principal Letters of Credit as the basis to support the creation of certain leverage of associated equity-based investment proceeds.

### RELATED APPLICATION

This application is a continuation-in-part of U.S. patent application Ser. No. 10/400,211 titled “INVESTMENT GRADE COLLATERALIZED VARIABLE RATE DEMAND NOTES” filed 27 Mar. 2003.

### FIELD OF THE INVENTION

The present invention relates to demand notes and similar financial products and the utilization thereof in conjunction with an equity-based venture capital investment.

### BACKGROUND OF THE INVENTION

The use of Variable Rate Demand Notes (VRDNs) as a tool for raising debt in the capital markets for the benefit of corporate and municipal entities has been popularized during recent years. VRDNs provide an ability to marry long-term debt and finance commitments with a short-term interest rate. Use of VRDNs has been further enhanced by certain regulatory dictates that create a beneficial environment for the sale and placement of financial products having characteristics consistent with traditional VRDNs.

The maturation of VRDNs as a generally accepted financial product has brought benefits to the financial market. Commercial banks may continue to originate and underwrite commercial, municipal or other debt-based projects without being saddled with substantial reserve requirements, the booking of cash loans or being otherwise restricted due to the size of a loan or a project being underwritten. These developments in the VRDN market have served to evidence how VRDNs, as a hybrid security having characteristics of both bond issues and traditional bank loans, have a commercial advantage over previously available corporate debt securities. VRDNs demonstrate how traditional term loan underwriting procedures that have been undertaken by banking institutions and underwriters may be utilized in an innovative manner to create and enhance a financial instrument that can be sold widely into the capital marketplace via private placement and remarketing agreements.

VRDNs can be sold or placed with money market funds, investment funds and virtually any other institution that has an interest in obtaining investment grade financial instruments meeting certain investment criteria to which VRDN's subscribe. The sale or placement of VRDNs is the foundation upon which traditional bank underwriting procedures may be openly coordinated with the institutional capital markets in order to access a pool of additional capital that otherwise would not have been accessible. This in turn brings additional capital to the likes of the typical project that would be underwritten and sold via a VRDN issuance.

Specifically, in today's United States-based institutional capital markets, institutional investors purchase financial products in substantial “blocks”, looking toward the credit rating of the instrument being acquired and the yield thereon as the two criteria upon which a determination to make an investment is afforded. An institutional investor is not inclined to undertake an underwriting process to determine the credit-worthiness of an investment opportunity. In addition, such an investment methodology would be both impractical and cost and time-prohibitive to investors in the capital markets. Instead, the institutional capital markets rely on investment bankers and underwriters to prepare, consolidate, package and arrange for the rating of proposed investments prior to the investor's review and consideration of such for inclusion in its portfolio.

Through the use of VRDNs in their prior art incarnation, investment grade commercial banks are able to: (i) identify projects or borrowers which they believe to be respectively credit worthy in their own right; (ii) apply standard underwriting methodologies of the commercial bank to review, evaluate and package each such subject project or borrower; (iii) approve such project for credit; (iv) provide credit to the subject project or borrower in the form of a specifically formatted letter(s) of credit (which takes advantage of certain regulatory guidelines relative to bank reserve requirements related to granting credit) rather than in the form of a credit line or loan; (v) attach its letter of credit to the issuance of a specific VRDN series for the benefit of the underwritten project or company such that the letter of credit enhances the credit worthiness of the VRDNs being issued, normally causing the customary credit rating of the debt obligations of the underwriting institution to be passed through to the VRDN's themselves; and (vi) facilitate or otherwise aid in the sale, placement and remarketing of the VRDN series with institutional capital markets investors from whom the actual debt proceeds will ultimately be raised and made available to the duly underwritten subject client or project of the commercial bank.

Ultimately, by utilizing VRDNs as the basis to raise the debt capital for a bank underwritten project, all parties to the VRDN transaction benefit. For instance, the borrower may be seeking finance that exceeds traditional lending limits or is otherwise unsuitable for underwriting on a cash loan or credit line basis. Alternatively, the borrower may simply, but definitively, benefit from advantages associated with short-term adjustable interest rates as applied to a properly commercially underwritten VRDN. The use of VRDNs affords the borrower the opportunity to take advantage of short-term interest rates while, via a remarketing agreement with a suitable securities remarketing agent for the duration of a VRDN term, obtaining a long-term financing commitment as facilitated by the commercial bank/underwriter.

The commercial bank that is underwriting the project or borrower also benefits. The commercial bank makes certain fee income related to the underwriting of the project, for example, it likely issues the letter of credit, may place the VRDNs in the institutional capital markets and, in some cases, may also remarket the VRDNs throughout the note term. The most consequential benefit to the commercial bank underwriter, however, is the ability to grant credit to the borrower in the form of a letter of credit. When the letter of credit is formatted in a certain manner, the bank is then able to grant credit with specific benefits and advantages in complying with certain lending reserve requirements as defined by regulatory guidelines, thus increasing the total potential amount of commercial lending business that the bank may conduct.

Finally, the institutional capital market investor benefits from the acquisition of the VRDNs by having available to it certain highly rated short-term investments which by regulatory guidelines it must maintain with respect to its portfolio. Specifically, the typical VRDN investors are money market funds, and to a lesser extent, corporations, trust departments and high net worth individuals. Of these, money market funds are generally required under the Securities and Exchange Commission Investment Company Act to invest in high quality short term obligations bearing interest at a rate calculated to give obligations purchased a market value of par. The hybrid nature of a VRDN makes this instrument attractive to fill this market need since the credit quality of the commercial bank/underwriter that issued the letter of credit that supports the payments due under the VRDNs is customarily of high quality and readily acceptable to the subject buyers.

In light of the foregoing, there is no doubt a benefit to the advent and development of the VRDN instruments in the debt markets in their prior art incarnation. However, prior art VRDNs contain several limitations that generally limit their use to financing projects that are (i) candidates for traditional term loan underwriting by a conventional commercial bank, (ii) specifically pre-identified, and (iii) usually financed via a single VRDN series issuance and enhanced via a single underwriter.

Specifically, the type of subject matter investment that is or can be converted to a VRDN placement generally exhibits the same credit worthiness as any other project which may be candidate for traditional term loan underwriting by a conventional commercial bank. Such a baseline credit criteria restricts the use of VRDNs in support of more speculative/higher return projects, non-speculative but transaction-based projects or other projects which may lack traditional collateral structures or historically definable revenue typically deemed acceptable to commercial banks in their standard underwriting models. By nature, these credit limitations make prior art VRDNs generally impractical for use by alternative capital companies, venture firms or investment banking houses which deem the risks and returns associated with projects of the foregoing descriptive categories acceptable and any other projects which fall outside the market-favored operations area or industries at the time of VRDN issuance and placement. Moreover, except for specific projects that meet the criteria set forth above, prior art VRDNs are not conducive to broad use by firms in the venture capital or investment banking industries.

Second, under current circumstances in which VRDNs are sometimes issued, the underlying project must be identified with specificity before the underwriting process may begin. This is a reasonable predicate to underwriting a project through traditional commercial means, but eliminates the possibility of utilizing VRDNs as a means to raise debt capital by a fund or investment manager in support of an investment pool or fund operating profile in which general investment criteria for subsequent investment are consistent with policy of the underwriter, but are not identified with particularity prior to the date of sale of the VRDNs.

Third, the prior art VRDN structure does not easily accommodate the process of conducting multiple issuances for the same project over a given period of time with a view to raising and accumulating a substantial amount of debt capital for projects which may require multiple or syndicated underwriters for the purposes of credit enhancing the VRDNs prior to sale into the capital market. For example, prior art VRDN structures make a phased syndication of underwriter participation logistically difficult on a large scale such as in the process of raising funds that may be required for a substantial singular acquisition. In such case, the substantial singular acquisition that would customarily require participation of more than one lender in a conventional lender environment cannot be accommodated and coordinated easily via a VRDN issuance. Thus, there still remains substantial room for improvement on this type of financial product.

In response to this need, a financial instrument, a Collateralized Variable Rate Demand Note (“CVRDN”) has been engineered and described under U.S. patent application Ser. No. 10/400,211 titled “Investment Grade Collateralized Variable Rate Demand Notes” filed 27 Mar. 2003, and U.S. patent application Ser. No. 10/860,743 titled “Investment Grade Collateralized Variable Rate Demand Notes and Computer-Based Reporting Related thereto” filed 6 Mar. 2004, the disclosures of which are hereby incorporated herein.

As a supplemental improvement related to the effective deployment of the CVRDN, what is thus needed is a framework for the implementation of the CVRDN which will induce its broader and effective use by equity funds, venture capital firms and investment banks such that the CVRDN (i) can act as a debt-based adjunct to available equity funding; (ii) can create a basis for a leverage mechanism that is internal to and more autonomously directed under the operations of an equity fund, venture capital firm or investment bank; (iii) can increase yield to the equity investor or limited partners of an equity fund as attributable to the fiscal performance of the leveraged component that is supported by the financial instrument without directly passing the leveraged exposure or risk through to the equity investor or limited partners; and (iv) can enhance the marketability of an equity fund or venture capital firm to potential investors or limited partners at the fund's inception or upon any supplemental capital raise due to the incorporation of such a leveraged mechanism arising from the deployment of the financial instrument.

### SUMMARY OF THE INVENTION

A financial process in accordance with the principles of the present invention can be applied to raise relatively inexpensive debt capital in support of the creation, establishment, growth or development of an investment or venture capital fund, whether as a stand-alone debt-based finance fund or as a supplement or adjunct to an existing equity fund, without specific projects having been identified in detail prior to CVRDN issuance, rating and placement. A financial process in accordance with the principles of the present invention promotes a greater availability of high-volume, institutional debt arising from the capital markets for the benefit of certain venture capital funds that otherwise would not be customarily substantial enough to garner such cost-effective and readily available finance.

A financial process in accordance with the principles of the present invention can be applied to create an investment leveraging mechanism within the body of an equity fund or, alternatively, established alongside an equity fund such that the fund managers may potentially increase the rate of return or yield on their equity fund. A financial process in accordance with the principles of the present invention potentially increases yield to the underlying equity investors or limited partners of an equity fund due to the fiscal performance of the leveraged component arising from the coordinated incorporation of the CVRDN instrument into the creation or operation of an equity-based fund without necessarily passing the leveraged exposure or risk through to the fund's equity investors or limited partners.

A financial process in accordance with the principles of the present invention enhances the marketability of an equity fund or venture capital operation to potential investors or limited partners at the fund's inception or upon any supplemental capital raise due to the incorporation of the debt-based and/or leveraged mechanism arising from the deployment of the CVRDNs. A financial process in accordance with the principles of the present invention can be used to generate substantial pools of debt-based capital by venture capital firms or investment banks as the basis to enhance and supplement available equity funding prior to the identification of particular beneficial projects.

A financial process in accordance with the principles of the present invention permits the individual project underwriting to effectively occur after-the-fact, fostering cooperation of equity funds and venture capital firms with the commercial banking industry in support of the development of a diverse network of commercial bank underwriters and underwriting methodologies which aids in defraying collective commercial bank underwriter risks and broadens the investment scope of the equity fund or venture capital fund. Thus, a financial process in accordance with the principles of the present invention assists in raising relatively inexpensive capital in support of privately managed investment or venture capital funds.

A financial process in accordance with the principles of the present invention can ease the logistical considerations of the credit underwriting criteria and by potentially fostering a degree of flexibility in the underlying collateral structures. A financial process in accordance with the principles of the present invention provides for the issuance of a dedicated letter of credit to secure the interest portion of the CVRDN in coordination with one or more respective letter(s) of credit that are utilized as credit enhancement to and security for the principal portion of a CVRDN. A financial process in accordance with the principles of the present invention fosters the creation of underwriting syndications for the principal portion of the CVRDN which contributes to better risk management and distribution amongst the venture capital firms, investment bankers, and commercial credit underwriter(s) of both leveraged and un-leveraged functions.

### BRIEF DESCRIPTION OF THE DRAWINGS

FIG. 1 is a methodological schematic depicting a general overview of a cooperative leverage process between an equity-based venture capital fund and a commercial credit underwriter using a CVRDN debt component in accordance with the principles of the present invention.

FIG. 2 is a methodological schematic showing an example of the calculation of leveraged returns to an equity investor in a venture capital fund incorporating the processes of FIG. 1.

FIG. 3 is a methodological schematic showing an overview of an internal or stand-alone leverage process in which a CVRDN financing fund is operated in tandem with an equity-based fund by a venture capital or investment banking firm in accordance with the principles of the present invention.

### DETAILED DESCRIPTION OF THE INVENTION

The financial process of the present invention enables the creation of a leveraged debt component which, as supported by a series of specifically coordinated financial mechanisms constituting a Collateralized Variable Rate Demand Note, may be utilized by venture capital and investment banking firms to supplement returns on equity investments. The financial process of the present invention builds upon the capabilities of the CVRDN as an investment grade debt instrument which is suitable for purchase by institutional investors and which enables the raising of low-cost debt finance over long-term periods via private placements that are effectuated through the capital markets. By employing the CVRDN as a cornerstone of the present invention, a venture capital or investment-banking firm is able to raise substantial pools of debt finance in tandem or coordination with conventional venture capital oriented equity-based investment pools such that leverage of equity dollars can be fostered. The financial process of the present invention further incorporates certain mechanisms and processes to contain the leverage risk within the realm of a conventional credit underwriter that is required under standard issuance protocols associated with the issuance of a CVRDN and that in the ordinary course of its business will have secured itself sufficiently against corresponding credit risk (which credit risk constitutes the basis of the leveraging mechanism), such that the leverage exposure does not translate to a risk borne by the equity fund or its respective partner/participants. By so doing, the present financial process acts to potentially increase gains to the equity fund or investor without correspondingly increasing exposure to that same group.

A financial process of the present invention expands upon the advantages of a CVRDN which, among other things, (i) establishes certain trust and reserve mechanisms that aid in the offset of note interest payable prior to final deployment of note proceeds into designated and selected investment or projects, thereby making it possible for financing to be raised well in advance of the implementation of the final intended investment thereof; (ii) produces a circumstance which permits debt capital to be raised in volume for general investment purposes rather than specific applications that have been pre-defined with a high degree of particularity as a predicate to raising financing; (iii) raises debt at an extremely low interest rate even after the addition of one-time and annualized fees and costs associated with the issuance and maintenance of the CVRDN Series; and (iv) allows the Issuer of the CVRDN Series to utilize a standardized debt security or financial instrument which need not materially vary based upon the nature of the underlying collateral or the intended use of proceeds derived from the sale or placement of the CVRDN. Therefore, placement efficiencies are raised and a foundation is created in the marketplace that is conducive to the volume placement, sale and remarketing of the CVRDNs in a manner that meets the short-term investment requirements of the subscriber (comparable to a prior art VRDN) while also accommodating the long-term debt requirements of the issuer under an operating profile which potentially provides greater flexibility as to use of proceeds.

Finally, a financial process of the present invention establishes a variety of efficiencies for a venture capital fund or investment banking firm that is acting as the CVRDN Issuer which enables the Issuer to raise low-cost debt in the capital markets which it may utilize in coordination with third party credit underwriters, thus potentially increasing or leveraging its potential for financial gain without significantly altering its financial exposure to a subject investment or project. Specifically, the financial process of the present invention represents a new debt-based investment tool which can create new investment approaches for the venture capitalist by fostering a cooperative syndication of risk arising from qualified projects, risk that could be deemed unacceptable to a venture capitalist or commercial credit underwriter as a stand-alone investment or loan, but with the introduction of the respective counter-party equity investor or credit/debt underwriter becomes acceptable.

### EXAMPLE

For the purposes of explanation and not to narrow the scope of the present invention, in the following example, a CVRDN issuance is enabled for issuance by a venture capital, investment banking or other similarly formatted investment fund in accordance with the financial process of the present invention. For the purposes of explanation and not to narrow the scope of the present invention, this process can be referred to as a CVRDN leveraged investment pool and, in the following example, the CVRDN leveraged investment pool may sometimes be referred to as a debt fund and from-time-to-time may be used in the examples in a manner absent leverage, but nonetheless affording additional and previously unavailable debt capital to a venture capitalist, investment banking or other similarly formatted entities as the CVRDN Issuer.

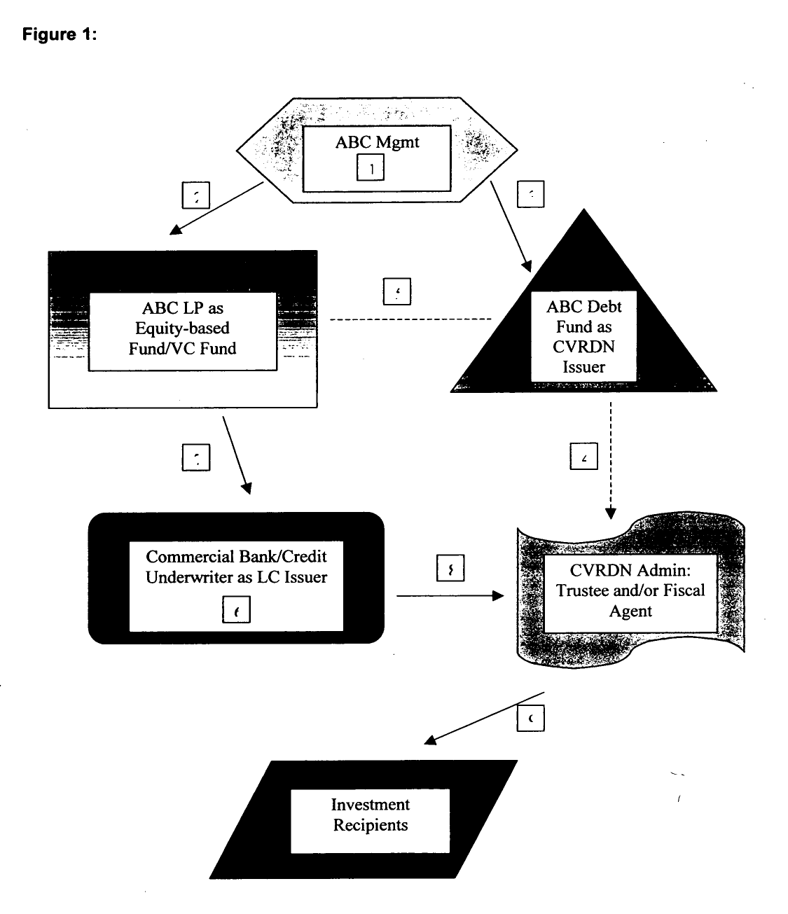

Referring first to FIG. 1, a methodological schematic depicting a general overview of a cooperative leverage process as profiled between an equity-based venture capital fund and a commercial credit underwriter using a CVRDN debt component in accordance with the principles of the present invention is seen. The operating management of a venture capital or investment banking group has elected to coordinate its existing or newly-formed equity-based, conventionally funded investment pool (“Equity Fund”) with a debt-based fund having a similar industry investment focus and which is to be capitalized with the proceeds of a CVRDN issuance (“Debt Fund”) (101).

Although not illustrated by this example, the Equity Fund may also be operating as a debt fund or be capitalized by borrowed funds without necessarily altering the financial process of the present invention. In this example, both funds taken together are responsible for the implementation of the investment criteria and are likely administered by associated or common management or directorship. Thus, through such affiliation, the Equity Fund may benefit from scheduling its projected or anticipated return on investment for its partners/participants based upon the anticipated leveraged or enhanced gains to be derived by association with the Debt Fund and resultant from the implementation of the financial process of the present invention. The management of the Debt Fund enables the management and implementation of the proceeds arising from the sale of the CVRDNs in a manner consistent with the investment criteria established related to that certain offering which description should not be inconsistent with the investment criteria established related to that certain offering of shares or interests in the Equity Fund.

The Equity Fund is established by its management for the purposes of raising equity funding from qualified investors through the sale of limited partnership interests or the equivalent (102). For the purposes of this example, the Equity Fund will raise US$100 million in Equity Funding proceeds that it will subsequently have available in support of structured investment in qualified projects or investments.

The Debt Fund is established by its management or its designated affiliate for the purposes of issuance and placement of one or more CVRDN Series in the institutional capital markets to established subscribers as the basis to raise low-cost debt financing to be used in conjunction with approved projects of the Equity Fund (103). For the purposes of this example, the Debt Fund will issue and place CVRDNs for principal value of US$250 million that will be available for investment or loan to qualified projects or investments.

As part of the CVRDN issuance process, CVRDN Proceeds will be deposited via the CVRDN designated Trustee (who pursuant to the terms of a Trust Indenture, administers the CVRDNs throughout the life of the CVRDN Series) with a Fiscal Agent, pending subsequent allocation to selected investments or projects (104). Procedurally, proceeds from the sale or placement of the CVRDNs (“Reserved Note Proceeds”) are placed on deposit in a dedicated and restricted reserve account (“Reserve Account”) with the Fiscal Agent under restricted interim asset management. The Fiscal Agent acts to administer the Reserved Note Proceeds on behalf of the Issuer and Trustee by the establishment, maintenance and management of the Reserve Account. The Reserve Account may be an interest-bearing account to be maintained at the Fiscal Agent's institution.

Reserved Note Proceeds are restricted for withdrawal from the Reserve Account until after the delivery of one or more of the acceptably formatted letter(s) of credit (the “Principal Letters of Credit”). While within the Reserve Account and due to the low rate of interest payable on the CVRDN as a function of that financial technology, the funds held on reserve are expected to produce an interim yield sufficient to minimally offset interest payable under the CVRDNs with a reasonable expectation of exceeding that rate, thereby effectuating a positive arbitrage of proceeds. Only upon receipt of an acceptable form of letter of credit (equal to the principal portion of proceeds to be onward loaned or invested to a selected project) in substitution for cash proceeds held on reserve are the CVRDN proceeds permitted to be released for scheduled investment in an approved project.

After evaluation and consideration, Equity Fund and Debt Fund will mutually agree to engage in an investment or loan to a given project or investment (105). Generally, the approved project or investment will have acceptable collateral or security available to secure the investment or, alternatively, will have sufficient cash flow to demonstrate ability to repay.

Once approved by the Equity Fund and Debt Fund, the project will be submitted for credit underwriting to a suitable commercial bank or investment grade credit underwriter (“Underwriter”) (106). Structurally, the Underwriter will be asked to issue one or more Principal Letter(s) of Credit for the full value of the scheduled investment in the subject project or investment against its receipt of an agreed value of cash funds, other acceptable collateral, or Equity Fund guarantees plus a first or second [security/collateral] position on the available collateral arising from the investment or project itself.

For example, a scheduled and approved project or investment may require funding of US$9 million in total, which pursuant to the CVRDN practices, requires the issuance of a US$9 million letter of credit. The Equity Fund may place US$5 million of its equity-based cash funding or other acceptable or equivalent assets or security on deposit with the Underwriter as a direct and partial collateral offset to the full US$9 million value of the letter of credit requested to be issued by the Underwriter. The Underwriter, against available collateral arising from the selected investment or project, will agree to underwrite an additional principal amount of its Principal Letter of Credit equal to US$4 million while still holding the US$5 million cash (or equivalent) collateral as the basis to secure the difference between the US$9 million and its US$4 million credit commitment. Additionally, Equity Fund may, as an extra inducement and at its option, undertake to issue contingent guarantees to the Underwriter to further defray possible losses in the event that the project collateral is insufficient upon an event of default.

In this example, the US$4 million figure represents the potential investment leverage as underwritten by the Underwriter. Under this structure there are multiple benefits to the parties: The Underwriter benefits by: (i) earning non-interest-based fees for the issuance of its letter of credit and receiving annualized fees for renewal thereof for the duration of the CVRDNs or until otherwise the project is repaid; (ii) receiving cash or cash equivalent security in pledge on its account for a minimum period of 3-5 years or as long as the project and the Underwriter's letter of credit remains outstanding; and (iii) participating in a transaction without having to make a cash loan or credit facility available, or rather, by expressly agreeing to issue a credit enhancement in the form of the Principal Letter(s) of Credit for the benefit of the subject project or investment. In addition, several ancillary benefits flow to the Underwriter such as reduced reserve requirements and, in most cases, an off-balance-sheet status to a portion of the letter of credit issuance transaction.

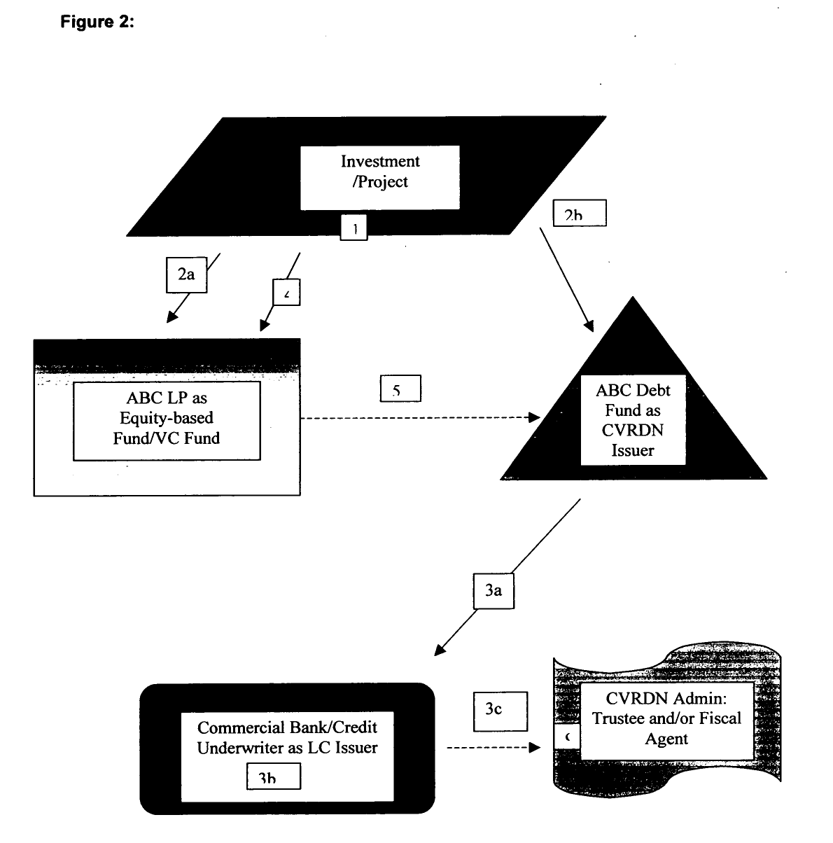

The Equity Fund and its respective limited partners benefit by gaining an effective leverage of its $5 million investment to a US$9 million level, thus potentially producing more attractive gains based upon a leverage multiplier (as detailed in greater detail in FIG. 2), better terms or higher ownership participation in the subject project or investment, preferred returns on investment, and/or the potential for debt service upon a greater principal value investment while segregating the potential for leveraged risk away from itself. Thus, the Equity Fund has also limited its potential for loss in this transaction to the actual amount invested in the project (which is that amount that has been deposited with and held by the Underwriter, in this case, US$5 million and which amount is supplementally secured by either a first or second security position on the assets of the project or investment, whichever is agreed with the Underwriter), barring any unforeseeable commercial or market factors that may raise the potential for additional loss.

The Debt Fund benefits by way of: (i) the accrual of interim earnings derived from the interim asset management of Reserved Proceeds prior to the disbursement of investment (or loan) proceeds to a subject investment or project against scheduled receipt of the Principal Letter(s) of Credit by the Trustee as intended; and (ii) the ability to generate return on investment on 100% debt-based funding derived from the capital markets via the deployment of the CVRDN financial technology. The Investment or Project benefits from the potential for more flexible or less expensive credit terms than may normally be expected in a full cash investment from a venture capitalist or investment bank on a non-leveraged equity-based investment transaction.

Against approval of the Underwriter, agreement as to leverage ratios, and agreement as to credit terms and underlying collateral structures with Equity Fund and Debt Fund, respectively, the Equity Fund will deposit (107) its cash or cash equivalent funds to the designated account at the Underwriter's institution. The Underwriter issues (108) its letter of credit in favor of the Trustee of the CVRDN Series pursuant to the requirements of the CVRDN technology. In our example, this would be for a face value of US$9 million, causing a 1:1 availability of proceeds from the Fiscal Agent in accordance with agreement with the Trustee.

Pursuant to the terms of the investment or loan agreement entered by and between Equity Fund and/or Debt Fund with the selected project or investment, CVRDN proceeds release (109) to the investment/project via the Fiscal Agent and the leveraged investment transaction has been effectuated.

Referring now to FIG. 2, a methodological schematic showing an example of the calculation of leveraged returns to an equity investor in a venture capital fund incorporating the processes of FIG. 1 is seen. In the present example, a subject investment/project has been deemed ‘successful’ as of the conclusion of its investment term (201), having met a specimen benchmark for performance. For the sake of example and not limitation, the investment/project has tripled in value. Carrying our example forward from FIG. 1, an initial US$9 million investment is illustrated as having been made by coordination of Equity Fund, the Underwriter, and Debt Fund. In our example, at time of investment conclusion, the investment is now worth an estimated US$27 million, or 3 times the original investment amount.

The investment/project repays the original investment amount to Equity Fund (202a) and Debt Fund (202b), respectively. In our example, this causes US$5 million to return to Equity Fund and US$4 million to return to Debt Fund. Debt Fund redistributes (203a) the payment received to the Underwriter in the amount of US$4 million to retire the outstanding leverage portion of the Underwriter's Principal Letter of Credit, thus causing the Underwriter's letter of credit to be fully secured (203b) for its face value by cash (that is, in our example, US$5 million originally deposited with Underwriter by Equity Fund plus US$4 million repayment of the leverage amount). Thereafter, either the Principal Letter of Credit will (203c) (i) be drawn and paid with the cash collateral being collected by the Underwriter or, alternatively, (ii) be cancelled with cash collateral paid into the Trustee as the basis to retire the corresponding CVRDNs.

Investment/project distributes (204) a prorated amount of gain on investment to Equity Fund which, for the purpose of illustration not limitation, would be US$10 million given an initial US$5 million invested amount, plus the scheduled gain on the leverage portion (less any interest or preferred return that may have been paid to cover CVRDN interest cost during the investment term) which for the purpose of example could be as much as US$8 million. Thus, under our example, by using the cooperative leverage function of the present invention, an equity-based investment in an investment/project that meets prescribed venture capitalist target performance over its term (in this example, 3 times the amount invested) will produce a total yield of an estimated US$18 million on a US$5 million core investment amount. Specifically, this total yield breaks out to (i) US$10 million gains on the core investment amount after reimbursement of the core investment amount, and (ii) US$8 million gains on the core leveraged amount, after reimbursement of the core leverage amount of US$4 million.

This additional leveraged performance amount is achieved without additional risk or exposure to Equity Fund, but rather, with the leveraged exposure resting with the Underwriter as offset by its direct security interest in the investment/project. The Equity Fund, upon investment, incurs liability for US$5 million in our example, with or without the incorporation of the leveraged mechanism.

Upon retirement or redemption of the principal portion of the CVRDNs utilized in the transaction (in our example, US$9 million), the final interest distribution is allocated and paid to Debt Fund (205) as the basis to distribute the final interest payment due under the CVRDNs. (As a footnote, Equity Fund will have been allocating and distributing, either directly or by agreement with the investment/project, payments of interest minimally equal to the interest due and accruing under the full US$9 million of effected CVRDNs.)

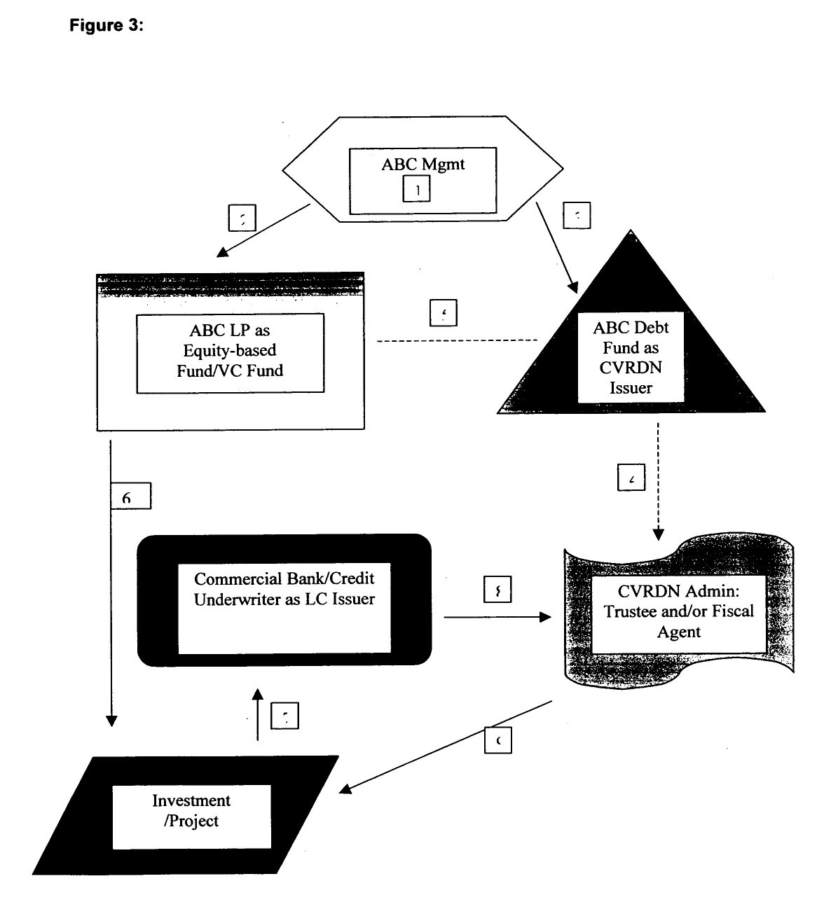

Referring now to FIG. 3, a methodological schematic showing an overview of an internal or stand-alone leverage process in which a CVRDN financing fund is operated in tandem with an equity-based fund by a venture capital or investment-banking firm in accordance with the principles of the present invention is seen. Similar to the foregoing example in FIG. 1, in this example the operating management of a venture capital or investment-banking group has elected to coordinate its existing or newly-formed Equity Fund with a Debt Fund having a similar industry investment focus and which is to be capitalized with the proceeds of a CVRDN issuance (301). Although not illustrated by this example, the Equity Fund may also be operating as a debt fund or be capitalized by borrowed funds without necessarily altering the financial process of the present invention.

In this example, both funds taken together are responsible for the implementation of the investment criteria and are likely administered by associated or common management or directorship. Thus, through such affiliation, the Equity Fund may benefit from scheduling its projected or anticipated return on investment for its partners/participants based upon the anticipated enhanced gains to be derived by association with the Debt Fund and resultant from the implementation of the financial process of the present invention. The management of the Debt Fund enables the management and implementation of the proceeds arising from the sale of the CVRDNs in a manner consistent with the investment criteria established related to that certain offering which description should not be inconsistent with the investment criteria established related to that certain offering of shares or interests in the Equity Fund.

The Equity Fund is established by its management for the purposes of raising equity funding from qualified investors through the sale of limited partnership interests or the equivalent (302). The Debt Fund is established by its management or its designated affiliate for the purposes of issuance and placement of one or more CVRDN Series in the institutional capital markets to established subscribers as the basis to raise low-cost debt financing to be used in conjunction with approved projects of Equity Fund (303).

Like the example seen in FIG. 1, as part of the CVRDN issuance process, CVRDN Proceeds will be deposited via the CVRDN designated Trustee (which pursuant to the terms of a trust Indenture, administers the CVRDNs throughout the life of the CVRDN Series) with a Fiscal Agent pending subsequent allocation to selected investments or projects (304). Procedurally, Reserved Note Proceeds are placed on deposit in a Reserve Account with the Fiscal Agent under restricted interim asset management. The Fiscal Agent acts to administer the Reserved Note Proceeds on behalf of the Issuer and Trustee by the establishment, maintenance and management of the Reserve Account. The Reserve Account may be an interest-bearing account to be maintained at the Fiscal Agent's institution.

Reserved Note Proceeds are restricted for withdrawal from the Reserve Account until after the delivery of one or more of the Principal Letters of Credit. While within the Reserve Account and due to the low rate of interest payable on the CVRDN as a function of the CVRDN financial technology, the funds held on reserve are expected to produce an interim yield sufficient to minimally offset interest payable under the CVRDNs with a reasonable expectation of exceeding that rate, thereby effectuating a positive arbitrage of CVRDN proceeds. Only upon receipt of an acceptable Principal Letter of Credit in equal substitution for cash proceeds held on reserve, are the CVRDN proceeds permitted to be released for scheduled investment in an approved project.

Also as in the example seen in FIG. 1, after evaluation and consideration Equity Fund and Debt Fund will mutually agree to engage in an investment or loan to a given project or investment (305). Generally, the approved project or investment will have acceptable collateral or security available to secure the investment or alternatively, will have sufficient cash flow to demonstrate ability to repay.

It is at this point that this example deviates from the example processes illustrated in FIG. 1. Once approved by the Equity Fund and Debt Fund, Equity Fund will make a direct equity investment in the approved and selected investment/project (306) pursuant to investment terms to be agreed, among which will be the subsequent provision of certain debt finance or credit facilities to the project for an agreed value. As and when agreed, Debt Fund in conjunction with Equity Fund will cause the investment/project to be taken through the credit underwriting process with the Underwriter (a suitable commercial bank or investment grade credit underwriter) (307) in support of the issuance of a suitable Principal Letter of Credit in favor of Debt Fund's designated CVRDN Trustee. Structurally, the Underwriter will be asked to issue the required Principal Letter(s) of Credit for the full value of the cash loan or credit facility to be granted by Debt Fund in favor of the investment/project. The issuance of the Principal Letter(s) of Credit will be based in part on the equity investment in the investment/project by Equity Fund, a first position on certain collateral of the investment/project being granted to the Underwriter, and any additional collateral or guarantees that may be agreed by the parties. Additionally, Equity Fund may, as an extra inducement and at its option, undertake to issue contingent guarantees to the Underwriter to further defray possible losses in the event that the project collateral is insufficient upon an event of default.

Under this structure there are multiple benefits to all parties. The Underwriter benefits by: (i) earning non-interest-based fees for the issuance of its Principal Letter of Credit and will thereafter receive annualized fees for renewal thereof for the duration of the CVRDNs or until otherwise the project is repaid; and (ii) the ability to participate in a transaction without having to make a cash loan or credit facility available, or rather, by expressly agreeing to issue a credit enhancement on behalf of Debt Fund for the benefit of the subject project or investment which in itself has several ancillary benefits to the Underwriter such as reduced reserve requirements and, in most cases, an off-balance-sheet status to a portion of the letter of credit issuance transaction.

The Equity Fund and its respective limited partners benefit by participating in a transaction in which a low-cost debt component is available “in-house” or via an affiliate as the basis to reduce finance costs to a given investment/project in which Equity Fund has made an investment, thus potentially producing more attractive gains resultant from the investment. The Debt Fund benefits by way of (i) the accrual of interim earnings derived from the interim asset management of Reserved Note Proceeds prior to the disbursement of investment (or loan) proceeds to a subject investment or project against scheduled receipt of the letter of credit by the Trustee as intended; (ii) the ability to better protect its position via making debt financing available to an investment/project in which Equity Fund, an affiliate or cooperating entity, is directly invested; and (iii) the ability to generate an attractive return on investment based upon 100% debt-based funding derived from the capital markets upon the intended deployment of the CVRDN financial technology.

The investment/project benefits from the potential for more flexible or less expensive credit terms than may normally be expected in a full cash investment from a venture capitalist or investment bank on a 100% equity-based investment transaction or from a commercial bank or capital markets for a conventional debt offering.

Against approval by the Underwriter, and agreement as to credit terms and underlying collateral structures with the investment/project, the Underwriter issues (308) its Principal Letter of Credit in favor of the Trustee of the CVRDN Series pursuant to the requirements of the CVRDN technology. Pursuant to the terms of the investment or loan agreement entered by and between Debt Fund, the investment/project and the Underwriter as secured by the investment/project collateral, CVRDN proceeds release (309) to the investment/project via the Fiscal Agent and the financing or loan transaction has been effectuated.

While the invention has been described with specific embodiments, other alternatives, modifications and variations will be apparent to those skilled in the art. For example, depending on the particular needs of an investment a financial process in accordance with the present investment can be combined with other financial instruments or processes in a single offering. Accordingly, it will be intended to include all such alternatives, modifications and variations set forth within the spirit and scope of the appended claims.

The following Glossary of Terms is set forth for convenience and should not be construed as limiting the scope of the present invention:

Glossary of Terms:

Collateralized Variable Rate Demand Note (CVRDN): a financial instrument as described in U.S. patent application Ser. No. 10/400,211 titled “Investment Grade Collateralized Variable Rate Demand Notes” filed 27 Mar. 2003.

Debt Fund: an entity established with debt-based financing proceeds derived from the issuance of one or more CVRDN Series for the purposes of providing low cost financing as the basis to create leverage of equity capital invested in a subject project or to coordinate with an Equity Fund having comparable investment criteria.

Equity Fund: an entity established with equity-based proceeds derived from the sale of limited partnership, shares or other interests to qualified sophisticated investors for the purposes of subsequently re-investing those proceeds in a subject project in coordination with a Debt Fund having comparable investment criteria.

Fiscal Agent: a banking institution having a credit agency rating of its long-term obligations of sufficient quality to meet minimal rating criteria set forth by the nominated credit rating agency which rates the CVRDNs; acts as the administrator and interim manager for Reserved Note Proceeds under certain guidelines and paying agent on behalf of the Issuer related to its scheduled investments.

Principal Letter of Credit Issuer: This entity may consist of several international banking institutions, insurers or functionally alternative investment grade comparable entities; however, in general there is a lead underwriting institution of sufficient credit quality (its credit rating according to Standard & Poor's Ratings Services, 55 Water Street, New York, N.Y. 10041 or Moody's Investors Service, Inc., 99 Church Street, New York, N.Y. 10007 or some other comparable credit rating agency) to meet minimal rating criteria set forth by the nominated credit rating agency which rates the CVRDNs. The Principal Letter of Credit Issuer is engaged for the purposes of issuance of its Principal Letter of Credit in support of the principal portion of the CVRDNs.

Indenture: the agreement entered by and between the CVRDN Issuer/Debt Fund and the Trustee which governs the administration of the CVRDNs and to which the Fiscal Agent is an administrative extension; also referred to as “Trust Indenture”.

Issuer: a bankruptcy remote special purpose entity which issues the CVRDNs, makes the offering for the purpose of attracting investment and subsequently manages and implements the proceeds of the sale of the CVRDNs prior to the application of the proceeds in a manner consistent with the investment criteria established upon CVRDN issuance and as stated in that certain offering memorandum.

Principal Letter(s) of Credit: the letter(s) of credit which secure the payment of the principal portion of the converted notes pursuant to the CVRDN technology.

Reserve Account: an interest bearing, depository account at the Fiscal Agent's institution designated for the reservation and holding of funds as security for the CVRDNs prior to the issuance and delivery of one or more Principal Letters of Credit.

Reserved Note Proceeds: those Note proceeds arising from a CVRDN issuance which are placed on deposit in the Reserve Account for the purpose of cash-securing the principal portion of the CVRDNs prior to the issuance and delivery of one or more Principal Letters of Credit.

Trustee: the entity responsible for the administration of the CVRDN Series for the benefit of its respective subscribers throughout the life of the CVRDNs; governed by the terms and conditions of the Indenture.

Underwriter: a suitable commercial bank or investment grade credit underwriter who issues one or more Principal Letter(s) of Credit; also referred to as the “Principal Letter of Credit Issuer”.

Variable Rate Demand Notes (VRDNs): short-term floating rate debt instruments that may be credit enhanced by application of a bank letter of credit or a municipal bond insurance policy.

1. A financial instrument comprising:
converting an investment grade cash-secured financial instrument into a letter of credit secured financial instrument; and
placing proceeds from the converted financial instrument on deposit in an account so as to create the potential for a positive arbitrage of those proceeds.

2. The financial instrument of claim 1 further wherein the positive arbitrage is sufficient to offset interest payable on the converted financial instrument while investment opportunities are being identified.

3. The financial instrument of claim 1 further wherein the financial instrument is initially rated by a credit rating agency based upon trust and reserve structures employed during an initial reserve period for the financial instrument and the financial instrument may be subsequently rated by a credit rating agency based upon a letter of credit-based credit enhancement mechanism.

4. The financial instrument of claim 1 further wherein proceeds from the financial instrument are operated and administered in accordance with a generic investment criteria.

5. The financial instrument of claim 1 further wherein proceeds from the financial instrument are placed in a reserve account for the purpose of cash-securing the financial instrument.

6. The financial instrument of claim 1 further including a second letter of credit issued to secure payment of interest due under the financial instrument.

7. The financial instrument of claim 1 further wherein the aggregate value of the letter of credit is equal to the principal portion of issued financial instruments which have been converted.

8. A method of financing comprising:
offering a financial instrument for the purpose of attracting investment;
placing proceeds from the financial instrument on deposit in an account so as to create the potential for a positive arbitrage of those proceeds; and
subsequently managing and implementing the proceeds from the financial instrument in a manner consistent with an investment criteria established related to that certain offering.

9. The method of financing of claim 8 further wherein the positive arbitrage is sufficient to offset interest payable on the financial instrument while investment opportunities are being identified.

10. The method of financing of claim 8 further including issuing a letter of credit to secure the payment of a principal portion of the financial instrument.

11. The method of financing of claim 8 further including initially rating the financial instrument by a credit rating agency based upon structures employed during an initial reserve period for the financial instrument and subsequently rating the financial instrument by a credit rating agency based upon a letter of credit-based credit enhancement mechanisms.

12. The method of financing of claim 8 further including the account being a reserve account.

13. A method of financing comprising:
creating an equity-based investment fund;
establishing a debt-based investment fund to provide leveraged liquidity to the equity-based fund by offering a debt-based financial instrument for the purpose of attracting investment;
coordinating the operation of the equity-based investment fund with the debt-based fund such that investment proceeds arising from the equity-based fund and the debt-based fund are managed in a manner consistent with a generic investment criteria; and
issuing a letter of credit to secure the repayment of a principal portion of the financial instruments issued by the debt-based fund.

14. The method of financing of claim 13 further including applying letter of credit such that proceeds of the debt-based fund are available to supplement the operation of the equity-based fund.

15. The method of financing of claim 13 further wherein the step of offering a debt-based financial instrument further comprises offering a collateralized variable rate demand note.

16. The method of financing of claim 13 further wherein the step of issuing a letter of credit further comprises depositing assets of the equity fund with a letter of credit issuer as an inducement to issuance of a letter of credit to secure the repayment of a principal portion of the financial instruments issued by the debt-based fund.
